(19) United States
(12) Patent Application Publication
(10) Pub. No.: US 2003/0122766 A1
(43) Pub. Date: Jul. 3, 2003

(54) Generation system for driving voltages of the rows and of the columns of a liquid crystal display

(75) Inventor: Francesco Pulvirenti, Acireale (IT)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: STMICROELECTRONICS S.r.l., Agrate Brianza (IT)

(21) Appl. No.: 10/326,724

(22) Filed: Dec. 20, 2002

(30) Foreign Application Priority Data
Dec. 27, 2001 (EP) 01830809.8

(51) Int. Cl. G09G 3/36

(52) U.S. Cl. 345/95

(57) ABSTRACT

The present invention refers to a generation system for driving voltages of the rows and of the columns of a liquid crystal display.

In an embodiment the generation system for driving voltages of the rows and of the columns of a liquid crystal display comprises: a first supply voltage; a second supply voltage; said first and second supply voltages supply a voltage generator circuit that provides at its output a first, a second, a third and a fourth voltage having respectively four prefixed values; characterized by further comprising at least a voltage generator that provides a first intermediary voltage having a first intermediary prefixed value of intermediary value with respect to said first and second supply voltages, said first intermediary voltage supplies part of said voltage generator circuit.

### DESCRIPTION

The present invention refers to a generation system for driving voltages of the rows and of the columns of a liquid crystal display.

Five voltage levels and the ground reference GND are necessary for driving a liquid crystal display (LCD) according to the technique denominated Improved Halt & Pleshko (IA& P). The first voltage level is called Vlcd and it is directly proportional to the lighting threshold of the liquid crystal and to the square root of the number of the driven rows. The other four voltage levels V2, V3, V4 and V5 are distributed between the Vlcd and GND voltages according to a law that depends on the square root of the number of the driven rows.

The different voltage levels are applied to the rows and columns with alternate phase in order to cancel the direct component of the voltage applied to the display, harmful for the liquid crystal. More particularly, in a frame period, or part of it, the rows are driven between the voltages V5 and Vlcd, while in the following period the rows are driven between the voltages GND and V2, in the same way the columns are driven between the voltages GND and V4 and between the voltages V3 and Vlcd.

Normally, the voltage Vlcd is generated by a charging pump starting from the supply voltage Vdd, while the other four voltage levels V2, V3, V4 and V5 are obtained from intermediary dividers of Vlcd, and applied to voltage followers that work as buffer circuits, normally supplied between the voltages Vlcd and GND.

The Applicant noticed that in this case the charge quantity, determined during a transition from the voltage Vlcd to the voltage V3 and equal to Cx(Vlcd-V3), where Cx is the capacity of the pixel, is transferred to ground GND. Similarly he noticed that the charge quantity determined during a transition from the voltage GND to the voltage V4, equal to Cx*V4, is taken from the supply voltage Vlcd. p The Applicant besides noticed that the main drawback of this architecture is that the ascending transitions of the driving signals always involve the collecting of charge from the node at the maximum voltage, while the descending transitions of the driving signals always involve the transfer of charge towards ground. Particularly he noticed that this determines efficiency problems, coming from the fact that the charges are transferred between farther voltages than it is not strictly necessary.

The Applicant also noticed that on the increasing of the number of rows, the voltages V2, V3, V4 and V5 tend to gather at the extreme supply values, that is the voltages V2 and V3 towards the voltage Vlcd while the voltages V4 and V5 towards the ground voltage GND.

In view of the state of the art described, an object of the present invention is to provide a generation system for driving voltages of the rows and of the columns of a liquid crystal display with greater efficiency than the known art.

According to the present invention, such and other objects are achieved by means of a generation system for driving voltages of the rows and of the columns of a liquid crystal display comprising: a first supply voltage; a second supply voltage; said first and second supply voltage supply a voltage generator circuit that provides at its output a first, a second, a third and a fourth voltage having respectively four prefixed values; characterized by further comprising at least one voltage generator that provides a first intermediary voltage having a first intermediary prefixed value of intermediary value with respect to said first and second supply voltages, said first intermediary voltage supplies part of said voltage generator circuit.

Thanks to the present invention it is possible to realize a generation system for driving voltages of the rows and of the columns of a liquid crystal display having a reduced power consumption.

The features and the advantages of the present invention will be made more evident by the following detailed description of a particular embodiment, illustrated as a non-limiting example in the annexed drawings, wherein:

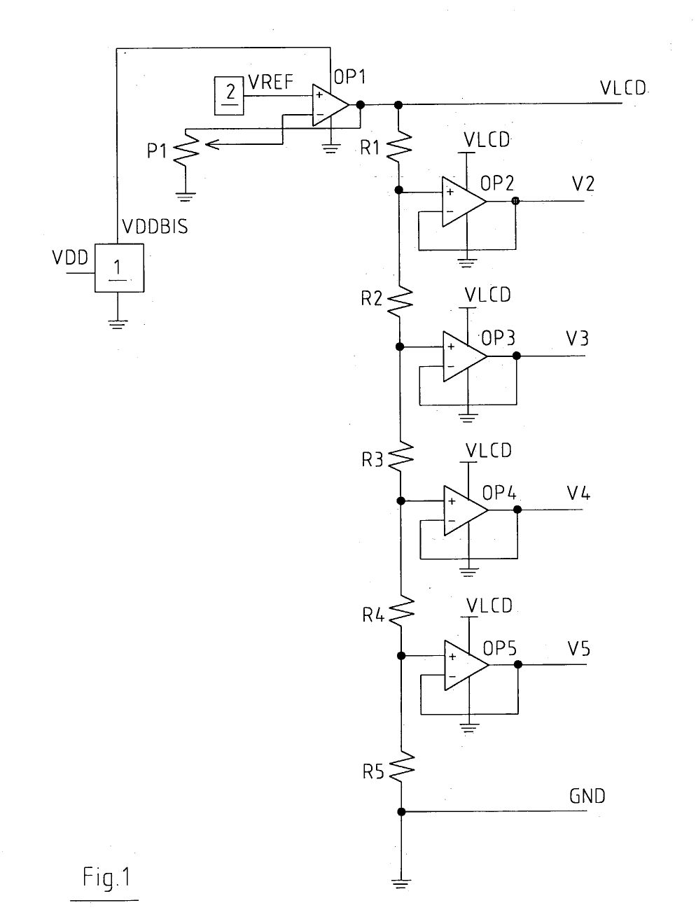

FIG. 1 represents a generation system for driving voltages of the rows and of the columns of a liquid crystal display according to the known art;

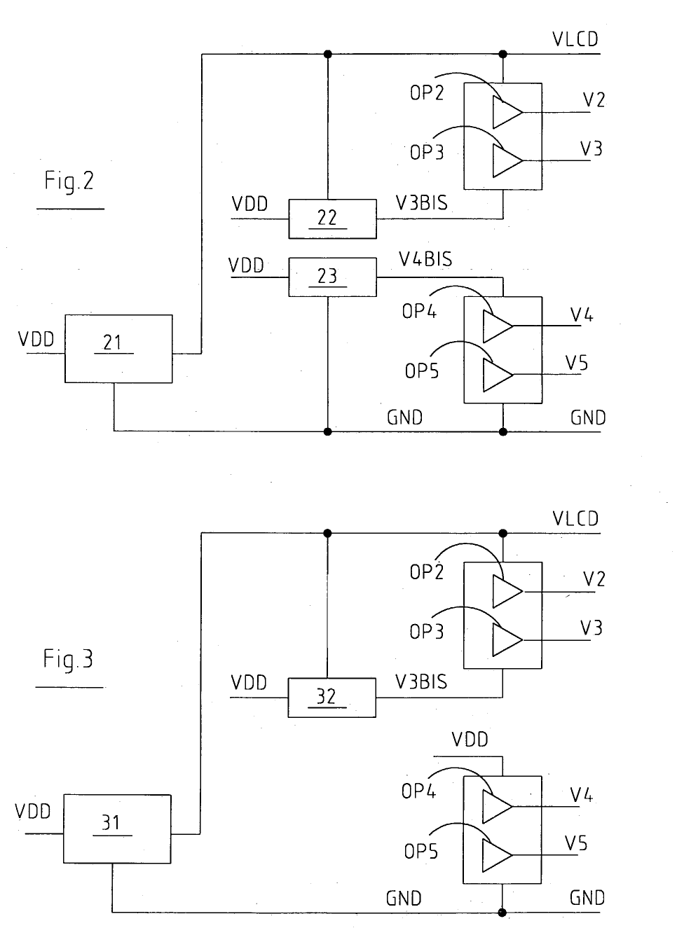

FIG. 2 represents schematically a first embodiment of a generation system for driving voltages of the rows and of the columns of a liquid crystal display according to the present invention;

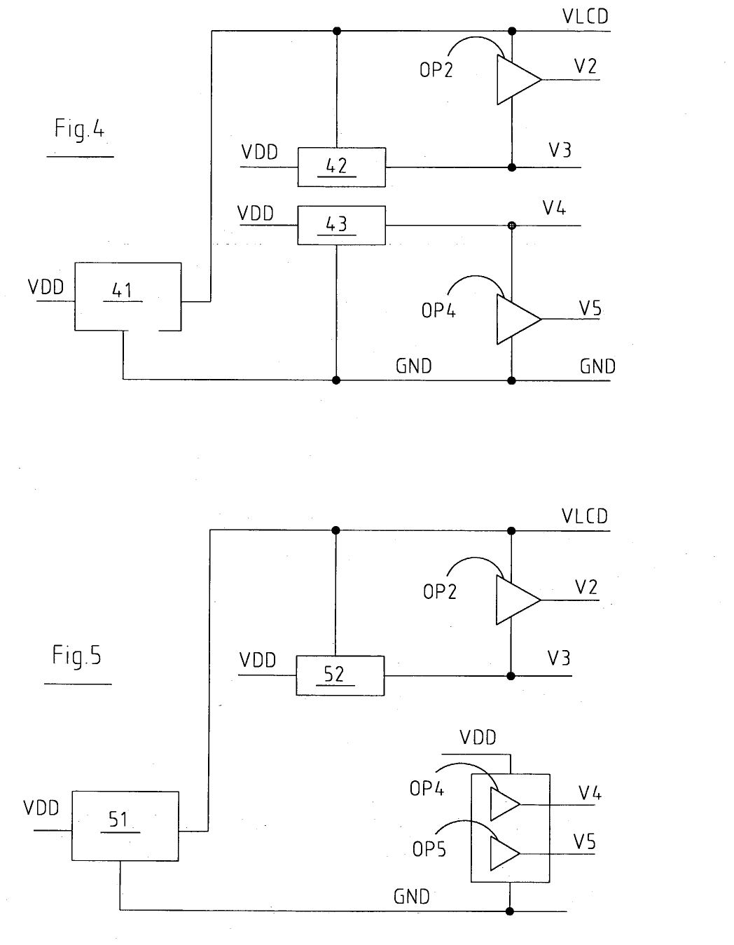

FIG. 3 represents schematically a second embodiment of a generation system for driving voltages of the rows and of the columns of a liquid crystal display according to the present invention;

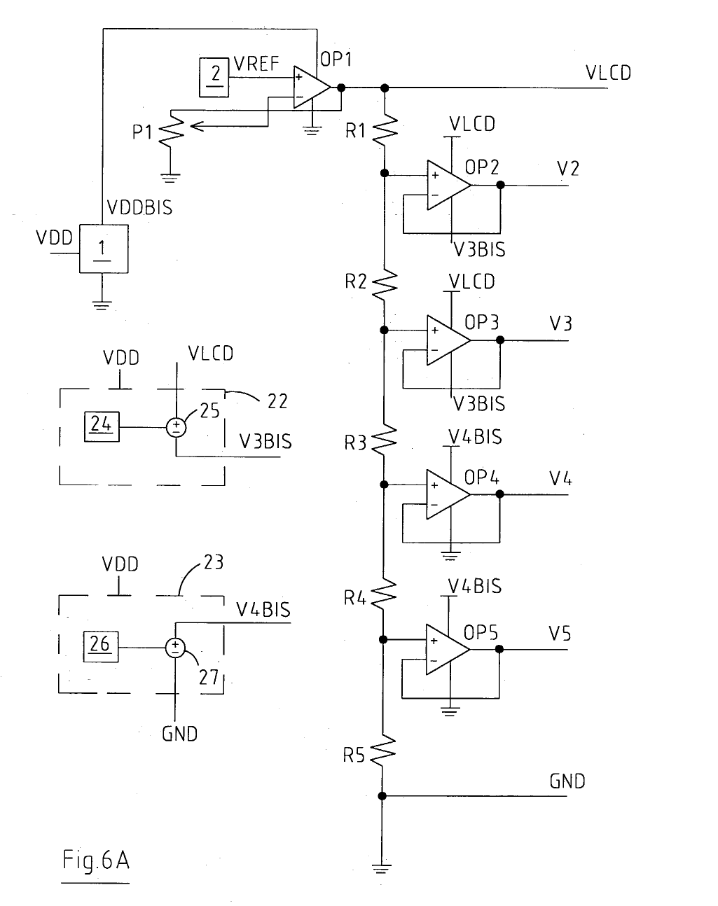

FIG. 4 represents schematically a third embodiment of a generation system for driving voltages of the rows and of the columns of a liquid crystal display according to the present invention;

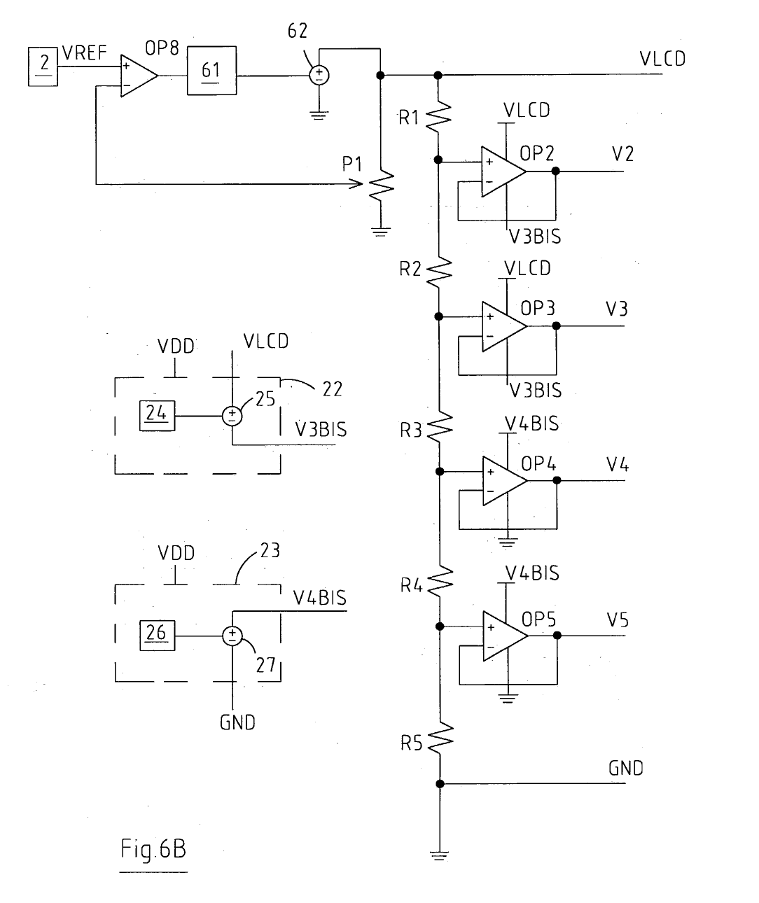

FIG. 5 represents schematically a fourth embodiment of a generation system for driving voltages of the rows and of the columns of a liquid crystal display according to the present invention;

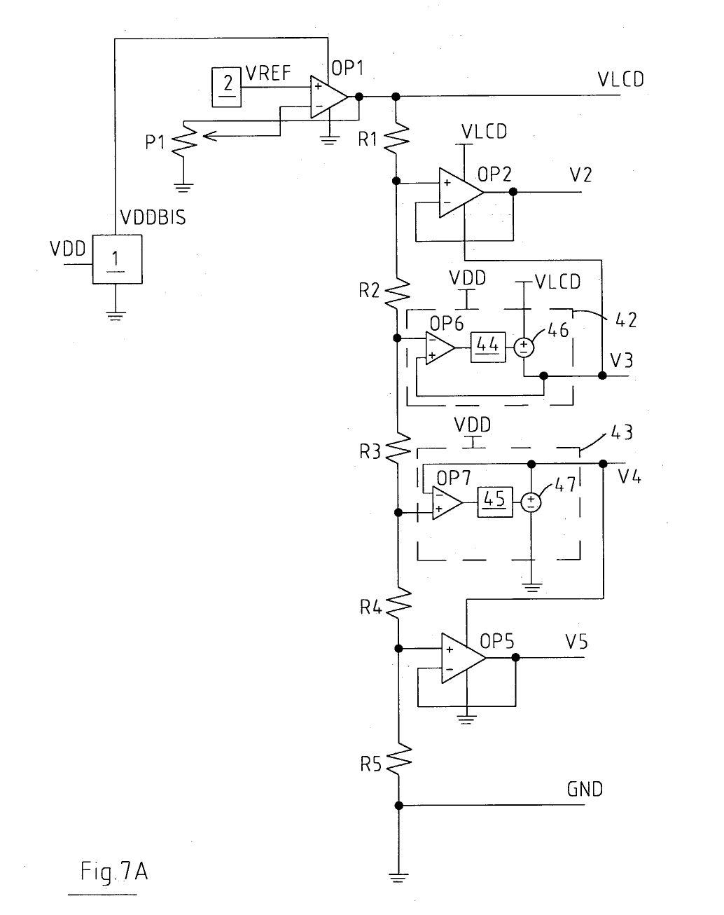

FIG. 6A and 6B represents schematically an implementation of the scheme of FIG. 2;

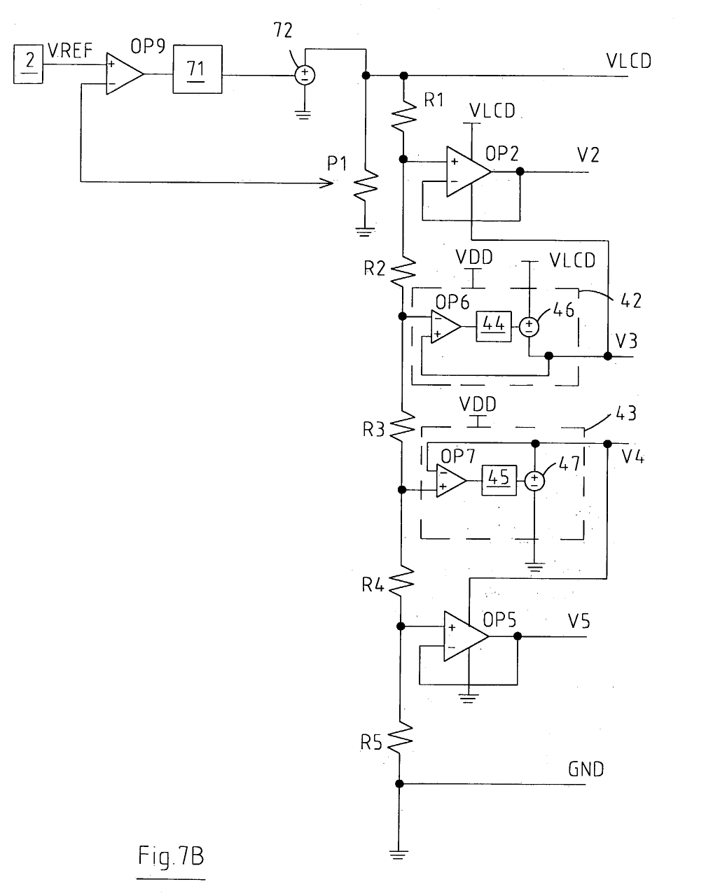

FIG. 7A and 7B represents schematically an implementation of the scheme of FIG. 4.

Referring now to FIG. 1, that represents a system according to the known art, the supply voltage Vdd supplies a positive charging pump 1 or, otherwise said, voltage converter, that provides in output the voltage Vddbis. The voltage Vddbis supplies an operational amplifier OP1 that provides a voltage Vlcd in output. The voltage Vlcd is applied to a terminal of a variable resistance P1, the other terminal of P1 is connected to ground GND. The cursor of the variable resistance P1 is connected to the negative terminal of the operational amplifier OP1. A reference voltage Vref produced by a voltage generator 2 is connected to the positive terminal of the operational amplifier OP1. The voltage Vlcd is applied to a resistance divider R1-R5 in turn connected to ground GND. The positive inputs of the operational amplifiers denominated respectively OP2-OP5 are applied in the junction nodes between a resistance and an other. The negative terminals of the operational amplifiers OP2-OP5 are connected to the respective outputs of the operational amplifiers OP2-OP5, as to constitute voltage followers. The operational amplifiers OP2-OP5 produce respectively the voltages V2-V5 at their output.

The operational amplifiers OP2-OP5, in the embodiment of FIG. 1, are supplied between the voltages Vlcd and GND.

The voltage generator 2 is designed so that it compensates the thermal variations and eventually other factors of the liquid crystal display.

We refer now to FIG. 2 that represents schematically a first embodiment of a generation system for driving voltages of the rows and of the columns of a liquid crystal display according to the present invention.

A positive charging pump 21 supplied by the voltage Vdd and referred to ground produces the voltage Vlcd in output. It is assumed for simplicity that the charging pump 21 also comprises the circuit of FIG. 1 constituted by the variable resistance P1, by the operational amplifier OP1 and by the voltage generator 2. Besides, also like below, the resistance divider R1-R5 is not represented for simplicity.

A negative charging pump 22 supplied by the voltage Vdd and referred to the voltage Vlcd produces the voltage V3bis in output. The operational amplifiers OP2 and OP3, here represented schematically for illustrative simplicity, are supplied between the voltages Vlcd and V3bis. A positive charging pump 23 supplied by the voltage Vdd and referred to the voltage GND produces the voltage V4bis in output. The operational amplifiers OP4 and OP5, also here represented schematically for illustrative simplicity, are supplied between the voltages V4bis and GND.

In this exemplary embodiment, and also in the following, the charging pumps are referred to the voltages as above described but they can also be referred to other voltages in the system, for example the negative charging pumps 22, 32, 42, 52 can be referred to Vddbis, and the positive charging pumps 21, 31, 41, 51, 23, 43 can be referred to Vdd. Besides, as upper voltage it is reported the voltage Vlcd, but also another voltage as for instance the voltage Vddbis (of FIG. 1) can be used, by adding a similar circuit to that of FIG. 1 for the generation of the voltage Vlcd.

Supposing of having a liquid crystal display with 64 rows and the voltages Vdd=1,6V, Vddbis=9,6V and Vlcd=9V, we will have V2=8V, V3=7V, V4=2V and V5=1V. We will have preferably V3bis=6,4V and V4bis=3,2V. That is we will have a voltage V3bis a bit smaller than the voltage V3, and a voltage V4bis a bit greater than the voltage V4, compatible with the number of cells in series present in the charging pumps.

The advantage will be therefore that the quantity of charge determined during a transition between a voltage and an other will be of considerably lower entity than in the known art, with a consequent small current consumption. Another advantage is that of the notable reduction of the silicon area taken by the system of voltage generation. In fact, the dimensions can be reduced having reduced the current load of the charging pump 21. For instance with a voltage Vlcd=10V and number of rows N =81 this type of solution takes the 40% less than of the silicon area normally taken.

We now refer to FIG. 3 that represents schematically a second embodiment of a generation system for driving voltages of the rows and of the columns of a liquid crystal display according to the present invention.

A positive charging pump 31 supplied by the voltage Vdd and referred to ground produces the voltage Vlcd in output. For simplicity it is assumed that the charging pump 31 also comprises the circuit of FIG. 1 constituted by the variable resistance P1, by the operational amplifier OP1 and by the voltage generator 2.

A negative charging pump 32 supplied by the voltage Vdd and referred to the voltage Vlcd produces the voltage V3bis in output. The operational amplifiers OP2 and OP3, here represented schematically for illustrative simplicity, are supplied between the voltages Vlcd and V3bis. In this case the operational amplifiers OP4 and OP5, also here represented schematically for illustrative simplicity, are supplied between the voltage Vdd and GND, if the voltage Vdd is greater than V4, but they can also be supplied with the voltage Vlcd or V3bis. As regards the scheme of FIG. 2, the positive charging pump 23 is eliminated.

We refer now to FIG. 4 that represents schematically a third embodiment of a generation system for driving voltages of the rows and of the columns of a liquid crystal display according to the present invention.

A positive charging pump 41 supplied by the voltage Vdd and referred to ground produces the voltage Vlcd in output. For simplicity it is assumed as above that the charging pump 41 also comprises the circuit of FIG. 1 constituted by the variable resistance P1, by the operational amplifier OP1 and by the voltage generator 2.

A negative regulated charging pump 42 supplied by the voltage Vdd and referred to the voltage Vlcd produces the voltage V3 in output. The operational amplifier OP2, here represented schematically for illustrative simplicity, is supplied between the voltage Vlcd and V3. A positive regulated charging pump 43 supplied by the voltage Vdd and referred to the GND voltage produces the voltage V4 in output. The operational amplifier OP4, also here represented schematically for illustrative simplicity, is supplied between the voltages V4 and GND.

The charging pumps 42 and 43 are defined regulated in the sense that they must supply directly the voltages V3 and V4 in output, and they therefore present a feedback loop for the output voltage control, as can be seen from FIG. 6 subsequently.

We now refer to FIG. 5 that represents schematically a fourth embodiment of a generation system for driving voltages of the rows and of the columns of a liquid crystal display according to the present invention.

A positive charging pump 51 supplied by the voltage Vdd and referred to ground produces in output the voltage Vlcd. For simplicity it is assumed as above that the charging pump 51 also comprises the circuit of FIG. 1 constituted by the variable resistance P1, by the operational amplifier OP1 and by the voltage generator 2.

A negative regulated charging pump 52 supplied by the voltage Vdd and referred to the voltage Vlcd produces the voltage V3 in output. The operational amplifier OP2, here represented schematically for illustrative simplicity, is supplied between the voltage Vlcd and V3. The operational amplifiers OP4 and OP5, also here represented schematically for illustrative simplicity, are supplied between the voltage Vdd and GND, if the voltage Vdd is greater than V4, but they can be also supplied with the voltage Vlcd or V3.

Also in this case the charging pump 52 is defined regulated in the sense that it must supply the voltage V3 directly in output. As regards the scheme of FIG. 4, the positive charging pump 43 is eliminated.

Besides, the circuits 22, 23, 32, 42, 43 and 52 are defined as charging pumps but they can be substituted by any other kind of voltage converter able to provide the voltage levels above defined in output.

We refer now to FIG. 6A that represents schematically an implementation of the scheme of FIG. 2, according the present invention.

In FIG. 6A the scheme of FIG. 1 has been modified by inserting the implementation of the negative charging pump 22 and of the positive charging pump 23, composed respectively by an oscillator 24 and 26 and by a controlled generator 25 and 27, that produce the voltage V3bis and the voltage V4bis respectively. As above described the voltages V3bis and V4bis supply the operational amplifiers OP2-OP5.

Such a circuit can be simplified unifying the oscillator signal of the charging pumps 22 and 23, generating it with only one common oscillator.

In the case of FIG. 3 the charging pump 23 is missing and the operationals are directly supplied by Vdd, like above specified.

We now refer to FIG. 7 that schematically represents an implementation of the scheme of FIG. 4.

In FIG. 7A the scheme of FIG. 1 has been modified by inserting the implementation of the negative regulated charging pump 42 and of the positive regulated charging pump 43, schematised respectively by an operational amplifier OP6 and OP7 whose output is connected to a voltage controlled oscillator 44 and 45 and by a controlled generator 46 and 47, that produce the voltage V3 and the voltage V4 respectively in output. The negative input of the operational amplifier OP6 is connected to the connection point between the resistance R2 and the resistance R3. The positive input of the operational amplifier OP6 is connected to the voltage V3. The positive input of the operational amplifier OP7 is connected to the connection point between the resistance R3 to the resistance R4. The negative input of the operational amplifier OP7 is connected to the voltage V4. The voltages V3 and V4 supply the operational amplifiers OP2 and OP5 as above described.

In the case of FIG. 5 the charging pump 43 is missing, and the operational amplifiers OP4 and OP5 are directly supplied by Vdd, as above specified.

In the examples here described the charging pumps 21, 31, 41 and 51 are defined as comprising the circuits of FIG. 1 that starting from the supply voltage Vdd provides the voltage Vlcd in output, but they can be also constituted by regulated positive charging pumps as for example the regulated positive charging pump 43.

As in fact it can be seen in FIG. 6B, the scheme of FIG. 6A has been modified implementing the charging pump that provides the voltage Vlcd, by means of a voltage generator 2 that produces a reference voltage Vref, that is applied to the positive input of an operational amplifier OP8. The output of the operational amplifier OP8 is connected to a voltage controlled oscillator 61 that controls a controlled generator 62, which produces the voltage Vlcd in output. The voltage Vlcd is applied to a terminal of a variable resistance P1, the other terminal of P1 is connected to ground GND. The cursor of the variable resistance P1 is connected to the negative terminal of the operational amplifier OP8.

Also in FIG. 7B, the scheme of FIG. 7A has been modified implementing the charging pump that provides the voltage Vlcd, by means of a voltage generator 2 that produces a reference voltage Vref, that is applied to the positive input of an operational amplifier OP9. The output of the operational amplifier OP9 is connected to a voltage controlled oscillator 71 that control a controlled generator 72, which produces the voltage Vlcd in output. The voltage Vlcd is applied to a terminal of a variable resistance P1, the other terminal of P1 is connected to ground GND. The cursor of the variable resistance P1 is connected to the negative terminal of the operational amplifier OP9.

Supposing of having Vdd=2.4 V, Vlcd=10 V, number of rows N=81, number of columns M=128, capacity of the pixel turns off Cxoff=0.8 pF, capacity of the pixel turns on Cxon=2.5 pF, efficiency of the charging pump η=80%, the innovative solution of FIG. 2 will have a current consumption similar to that of the known art, when the pixel will be all turned on or all turned off, and equal respectively to 40 μA and 125 μA. While in the case in which there are many variations of brightness of the pixel, as for example in the case of the display control (checker board) we will have consumption equal to 750 μA for the known art and equal to 215 μA for the solution of FIG. 2, with a consumption reduction greater than 70%.

1. Generation system for driving voltages of the rows and of the columns of a liquid crystal display comprising: a first supply voltage; a second supply voltage; said first and second supply voltages supply a voltage generator circuit that provides at its output a first, a second, a third and a fourth voltage having respectively four prefixed values; characterized by further comprising at least one voltage generator that provides a first intermediary voltage having a first intermediary prefixed value of intermediary value with respect to said first and second supply voltages, said first intermediary voltage supplies part of said voltage generator circuit.

2. Generation system for driving voltages of the rows and of the columns of a liquid crystal display according to claim 1 characterized in that said voltage generator circuit comprises four buffer circuits that provide said four voltages and that said first intermediary voltage supplies at least two of said four buffer circuits.

3. Generation system for driving voltages of the rows and of the columns of a liquid crystal display according to claim 1 characterized in that said voltage generator provides in output a fifth and a sixth reference voltages having respectively a fifth and a sixth prefixed value, said fifth reference voltage corresponds to said first supply voltage and said sixth reference voltage corresponds to said second supply voltage.

4. Generation system for driving voltages of the rows and of the columns of a liquid crystal display according to claim 1 characterized by comprising a further voltage generator that provides a second intermediary voltage having a second intermediary prefixed value of intermediary value respect to said first and second supply voltage, said second intermediary voltage supplies at least one of said four buffer circuits.

5. Generation system for driving voltages of the rows and of the columns of a liquid crystal display according to claim 1 characterized in that said first intermediary voltage corresponds to said second prefixed voltage.

6. Generation system for driving voltages of the rows and of the columns of a liquid crystal display according to claim 1 characterized in that said second intermediary voltage corresponds to said third prefixed voltage.
